(19) United States
(12) Patent Application Publication
(10) Pub. No.: US 2013/0313986 A1
(43) Pub. Date: Nov. 28, 2013

(54) LIGHT EMITTING APPARATUS

(71) Applicant: SAMSUNG ELECTRONICS CO., LTD., Suwon-si (KR)

(72) Inventors: Je Won KIM, Seoul (KR); Sung Tae KIM, Seoul (KR); Chan Mook LIM, Seongnam (KR)

(73) Assignee: SAMSUNG ELECTRONICS CO., LTD., Suwon-si (KR)

(21) Appl. No.: 13/900,288

(22) Filed: May 22, 2013

(30) Foreign Application Priority Data
May 22, 2012 (KR) 10-2012-0054366

(51) Int. Cl. H05B 33/08

(52) U.S. Cl. CPC H05B 33/0809
USPC 315/192; 315/185 R

(57) ABSTRACT

A light emitting apparatus includes a power supply providing power having a predetermined frequency, a plurality of light emitting diode arrays, and at least one frequency converter. The light emitting diode arrays are electrically connected to the power supply and respectively have an array structure in which at least one or more light emitting diodes are connected to one another in series. The at least one frequency converter is connected to both ends of the power supply, and configured to modulate a frequency of the power provided from the power supply and provide a modulated electrical signal to at least one of the plurality of light emitting diode arrays.

### CROSS-REFERENCE TO RELATED APPLICATION

This application claims benefit of priority to Korean Patent Application No. 10-2012-0054366 filed on May 22, 2012, in the Korean Intellectual Property Office, the entire contents of which are hereby incorporated by reference.

### TECHNICAL FIELD

The present inventive concept relates to a light emitting apparatus.

### BACKGROUND

A light emitting diode (LED) is a semiconductor light emitting device capable of generating various colors of light through the recombination of electrons and holes at a junction between p-type and n-type semiconductors when a current is applied thereto. Compared to light emitting devices based on filaments, such semiconductor light emitting devices have favorable characteristics such as a long lifespan, low power consumption, excellent initial operating characteristics, high vibration resistance, and the like. Hence, demand for semiconductor light emitting devices is continuously increasing.

Meanwhile, such light emitting diodes are generally driven by direct current (DC) power, and thus, in order to use light emitting diodes with alternating current (AC) power, a process in which input alternating current power is first rectified and smoothed, and converted into direct current power through a constant voltage circuit, is demanded. However, a smoothing circuit and a constant voltage circuit may generally cause an LED module to be complicated in terms of the configuration thereof and may lead to deteriorations in lifespan, reliability and stability, and the like, of a device.

In order to solve these defects, an LED driving circuit, directly driven by alternating current power, has been proposed. However, since power having a predetermined frequency is used, an LED may repeatedly perform on and off operations according to a frequency applied thereto, leading to a flicker phenomenon in which an LED flickers when viewed externally, and there may be deterioration or limitation in emitted light quality.

### SUMMARY

An aspect of the present inventive concept relates to a light emitting apparatus in which flicker phenomenon is improved.

An aspect of the present inventive concept encompasses a light emitting apparatus including a power supply providing power having a predetermined frequency, a plurality of light emitting diode arrays, and at least one frequency converter. The plurality of light emitting diode arrays are electrically connected to the power supply and respectively have an array structure in which at least one or more light emitting diodes are connected to one another in series. The at least one frequency converter is connected to both ends of the power supply, and configured to modulate a frequency of the power provided from the power supply and provide a modulated electrical signal to at least one of the plurality of light emitting diode arrays.

The at least one frequency converter may be a plurality of frequency converters. At least two of the plurality of light emitting diode arrays may respectively receive the modulated electrical signal from at least two of the plurality of frequency converters, such that amounts of frequency modulation of the at least two frequency converters may be different from each other.

The amounts of frequency modulation of the at least two frequency converters may be set to increase the frequency of power provided from the power supply.

The amounts of frequency modulation of the at least two frequency converters may be set to decrease the frequency of power provided from the power supply.

Alternatively, at least one of the at least two frequency converters may be set to increase the frequency of power provided from the power supply, and the remaining one of the at least two frequency converters may be set to decrease the frequency of power provided from the power supply.

At least one of the plurality of light emitting diode arrays may further include a resistor connected to the at least one light emitting diode array in series, such that the resistor controls an amount of current conducting the at least one light emitting diode array.

A resistance value of the resistor may be set such that a frequency of power conducting the light emitting diode array including the resistor is not higher than a frequency of power conducting a different light emitting diode array.

A resistance value of the resistor may be set such that the frequency of power conducting the light emitting diode array including the resistor is not lower than a frequency of power conducting a different light emitting diode array.

The power supply may include an alternating current power source having a predetermined frequency and a rectifier connected to both ends of the alternating current power source to rectify alternating current power so as to provide the rectified alternating current power.

At least one of the plurality of light emitting diode arrays may further include a subarray connected to the at least one light emitting diode array in parallel, and the subarray may have an array structure in which at least one or more light emitting diodes are connected in series.

At least one of the plurality of light emitting diode arrays may further include a subarray connected to the at least one light emitting diode array in parallel, and the subarray may have an array structure in which at least one or more light emitting diodes are connected in series and may have a reverse polarity with respect to a polarity of the at least one light emitting diode array.

Another aspect of the present inventive concept relates to a light emitting apparatus including a power supply providing power having a predetermined frequency, a plurality of light emitting diode arrays, and a plurality of frequency converters. The plurality of light emitting diode arrays respectively have an array structure in which at least one or more light emitting diodes are connected to one another in series. The plurality of frequency converters are connected to both ends of the power supply, and configured to modulate a frequency of the power provided from the power supply and provide modulated electrical signals to respective ones of the plurality of light emitting diode arrays such that frequencies of the modulated electrical signals are different from one another.

Amounts of frequency modulation of the plurality of frequency converters may be set to increase the frequency of power provided from the power supply.

Amounts of frequency modulation of the plurality of frequency converters may be set to decrease the frequency of power provided from the power supply.

At least one of the plurality of frequency converters may be set to increase the frequency of power provided from the power supply, and the remaining ones of the plurality of frequency converters may be set to decrease the frequency of power provided from the power supply.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept. In the drawings, the thickness of layers and regions may be exaggerated for clarity.

FIG. 1 is a schematic equivalent circuit diagram of a light emitting apparatus according to an embodiment of the present inventive concept.

FIGS. 2A and 2B are graphs schematically illustrating a wavelength of a voltage applied to a light emitting diode array and an amount of light emitted from the light emitting diode array, when a frequency converter according to an embodiment of the present inventive concept is not applied thereto.

FIGS. 3A to 3D are graphs schematically illustrating an amount of light emitted from respective light emitting diode arrays and a total light emission amount of a light emitting apparatus according to an embodiment of the present inventive concept.

FIGS. 4 to 6 are schematic equivalent circuit diagrams of a light emitting apparatus according to another embodiment of the present inventive concept.

FIGS. 7A to 7D are graphs schematically illustrating waveforms of a voltage applied to respective light emitting diode arrays according to the embodiment of the present inventive concept in FIG. 6.

### DETAILED DESCRIPTION OF THE EMBODIMENTS

Examples of the present inventive concept will be described below in more detail with reference to the accompanying drawings. The examples of the present inventive concept may, however, be embodied in different forms and should not be construed as limited to the examples set forth herein.

In the drawings, the shapes and dimensions of elements may be exaggerated for clarity, and the same reference numerals will be used throughout to designate the same or like elements.

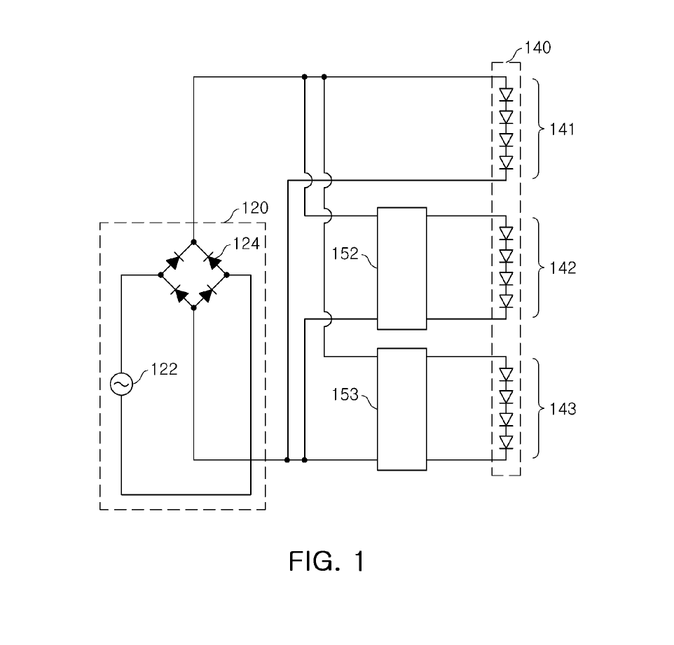

FIG. 1 is a schematic equivalent circuit diagram of a light emitting apparatus according to an embodiment of the present inventive concept. With reference to FIG. 1, a light emitting apparatus according to an embodiment of the present inventive concept may include a power supply 120, a plurality of light emitting diode arrays 140 electrically connected to the power supply, and at least one or more frequency converters 152 and 153.

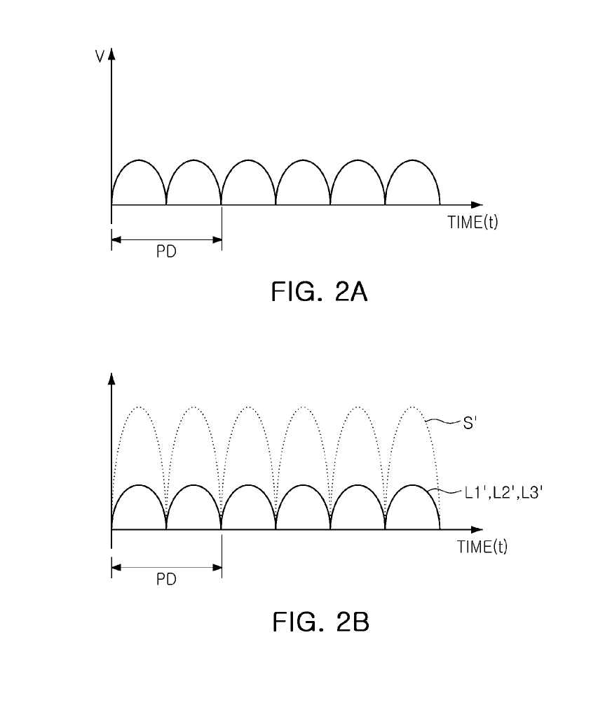

In an embodiment of the present inventive concept, the power supply 120 may include an alternating current (AC) power source 122 having a predetermined frequency and a rectifier 124 rectifying the alternating current power. The rectifier 124 may be a bridge circuit configured of a plurality of rectifier element (e.g. diode, light emitting diode), for example, as a full-wave rectifying circuit. In this case, a voltage waveform output from the power supply 120 may have a form as schematically illustrated in FIG. 2A.

The plurality of light emitting diode arrays 140 may respectively have an array structure in which at least one or more light emitting diodes are connected to each other in series, and at least one light emitting diode array 142 or 143 may be connected to an output part of the at least one frequency converter 152 or 153 to be described below.

As shown in FIG. 1, the remaining light emitting diode array, e.g., 141, may directly be connected to both ends of the power supply 120. Unlike the illustration of FIG. 1, the totality of a plurality of light emitting diode arrays disposed in the light emitting apparatus may also be connected to both ends of respective ones of a plurality of frequency converters instead of being directly connected to both ends of the power supply 120.

According to an embodiment of the present inventive concept, three light emitting diode arrays (hereinafter, referred to as first to third light emitting diode arrays 141, 142 and 143) may be provided, and each light emitting diode array may include four light emitting diodes, but the present inventive concept is not limited thereto. That is, the number of the plurality of light emitting diode arrays and the number of light emitting diodes included in each light emitting diode array may also be set according to the magnitude of a voltage applied thereto, an amount of light required therefor, a driving voltage included in the respective light emitting diode, the size of a light emitting apparatus, and the like. In addition, the numbers of light emitting diodes included in the respective light emitting diode arrays may also be different from each other.

When all of the plurality of light emitting diode arrays 140 are directly connected to the power supply 120, a wavelength of a voltage applied to all of the plurality of light emitting diode arrays may be equal to a wavelength illustrated in FIG. 2A. Therefore, the amount of light output from the respective light emitting diode arrays 141, 142 and 143 may be equal to L1′ to L3′, schematically illustrated in FIG. 2B, similar to a wavelength of the voltage applied thereto.

In this case, a total amount of output light S′ from the light emitting apparatus may be represented as the sum (L1′+L2′+L3′) of amounts of light output from the plurality of light emitting diode arrays. That is, as illustrated in FIG. 2B, the total amount of output light S′ from the light emitting apparatus may have a relatively great vibrating amplitude, and a phenomenon in which all of the light emitting diode arrays are simultaneously turned off, that is, do not emit light, may repeatedly occur at least several times during each period PD of alternating current power, thus deteriorating a quality of output light.

Therefore, the light emitting apparatus according to an embodiment of the present inventive concept may include a frequency converter 152 and 153 connected to respective both ends of the power supply 120 and modulating a frequency of power supplied from the power supply 120 to provide a modulated electrical signal to at least one of the plurality of light emitting diode arrays 140.

That is, at least one of the plurality of light emitting diode arrays 140 may be connected to an output part of the frequency converter 152 and 153, and thus, the at least one light emitting diode array 142 and 143 may receive power modulated by the frequency converter 152 and 153.

Here, the frequency converters 152 and 153 may be a cyclo-converter, an AC-to-AC converter, or the like, modulating a frequency of power having a predetermined frequency provided from the power supply 120, but the present inventive concept is not limited thereto. Thus, any light emitting apparatus may be employed as long as it is an element capable of modulating a frequency of alternating current power.

According to an embodiment of the present inventive concept as shown in FIG. 1, two light emitting diode arrays 142 and 143 of three light emitting diode arrays 141, 142 and 143 may be connected to both ends of the frequency converters, that is, a first frequency converter 152 and a second frequency converter 153, respectively. The remaining light emitting diode array, e.g., 141 may not be connected to the frequency converters 152 and 153 so as to receive power provided from the power supply 120 without modulation of the frequency thereof.

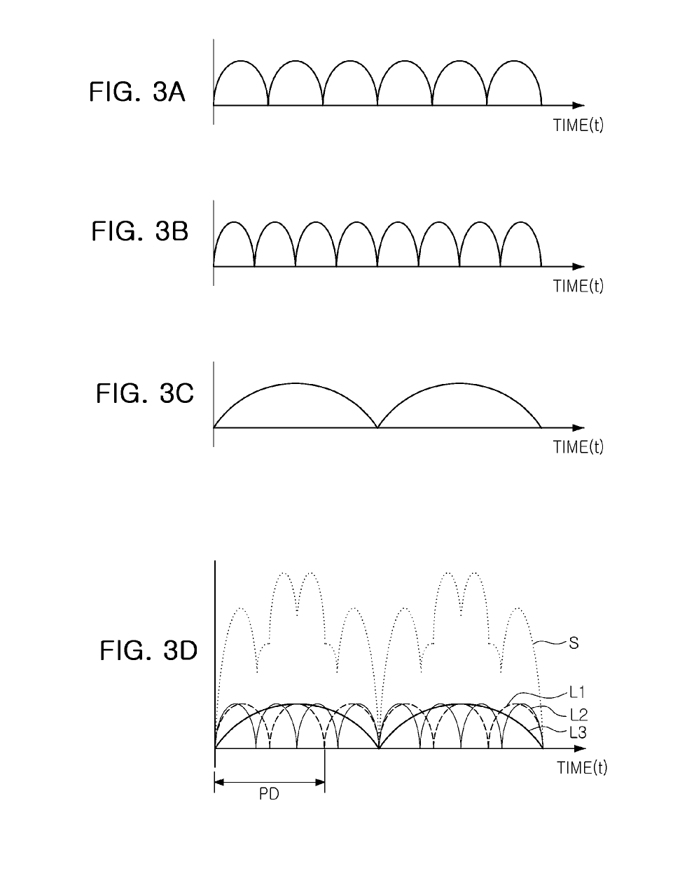

In an embodiment of the present inventive concept, the first and second frequency converters 152 and 153 may be set to have different levels of frequency modulation. For example, the first frequency converter 152 may modulate a frequency of power provided from the power supply 120 to be increased by 4/3 thereof, and the second frequency converter 153 may modulate a frequency of power provided from the power supply 120 to be decreased by ⅓ thereof. In this case, schematic voltage waveforms of power respectively applied to the first to third light emitting diode arrays 141, 142 and 143 may be equal to as those illustrated in FIGS. 3A to 3C, respectively.

According to the description above, the amount of light output from the respective first to third light emitting diode arrays 141, 142 and 143 may be equal to L1 to L3 schematically illustrated in FIG. 3D, and the total amount of light from the light emitting apparatus may be equal to S illustrated in FIG. 3D, as the sum (L1+L2+L3) of amounts of light output from the plurality of light emitting diode arrays.

Here, as compared with the total amount of output light S′ from the light emitting apparatus shown in FIG. 2B, it can be appreciated from that of FIG. 3D that the phenomenon in which all of the light emitting diode arrays are simultaneously turned off during each period PD of alternating current power, that is, do not emit light, is effectively reduced with regard to a vibrating amplitude of the total amount of output light and input alternating current power.

Meanwhile, unlike the embodiment illustrated in FIG. 1, even when only a frequency converter for reducing a frequency of power provided from the power supply or a frequency converter for increasing a frequency of power provided from the power supply is used, the frequency converter may be employed in the light emitting apparatus according to an embodiment of the present inventive concept. In addition, unlike the illustration in FIG. 1, none of the plurality of light emitting diode arrays 140 may be directly connected to the power supply 120, and all of the plurality of light emitting diode arrays 140 may receive modulated power from the plurality of respective frequency converters.

As such, according to an embodiment of the present inventive concept a flicker phenomenon may be improved in a light emitting apparatus by using a plurality of light emitting diode arrays in which a period of light emission is changed by power having different frequencies through the frequency modulation of alternating current power.

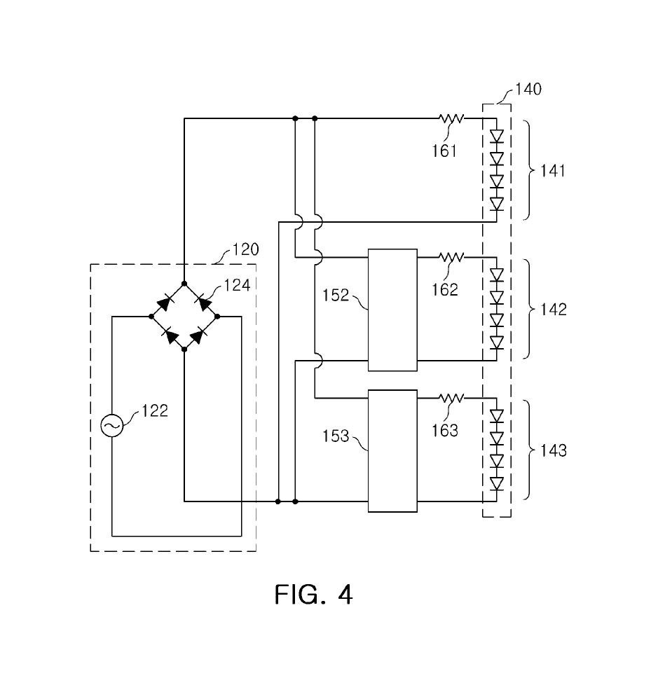

FIG. 4 is a schematic equivalent circuit diagram of a light emitting apparatus according to another embodiment of the present inventive concept. With reference to FIG. 4, a resistor 161, 162 or 163 may be connected to one end of at least one light emitting diode array 141, 142 or 143 of the plurality of light emitting diode arrays 140 in series.

The resistors 161, 162 and 163 may change a relative amount of current flowing in the light emitting diode arrays 141, 142 and 143 of the plurality of light emitting diode arrays 140 connected thereto in series. That is, according to an embodiment of the present inventive concept, the respective light emitting diode arrays 141, 142 and 143 may receive a voltage having the same magnitude (amplitude) from the power supply 120. Here, when the resistors 161, 162 and 163 respectively connected to the light emitting diode arrays 141, 142 and 143 in series are added thereto, the relative amount of current flowing in the respective light emitting diode arrays may be reduced in proportion to a resistance value of the resistors 161, 162 and 163.

The amount of output light from the plurality of light emitting diode arrays may be respectively adjusted through a simple process of adding a resistor. In addition, a flicker phenomenon may be effectively improved by appropriately setting a resistance value of the resistor such that the total amount of output light may be more constant.

For example, when the magnitude of frequency of power applied to respective light emitting diode arrays from among the first to third light emitting diode arrays becomes lower in the order of the second light emitting diode array 142, the first light emitting diode array 141 and the third light emitting diode array 143, a resistance value of the respective resistors may be set to be reduced in the order of a second light emitting diode connection resistor, that is, the resistor 162 connected to the second light emitting diode array 141, a first light emitting diode connection resistor, that is, the resistor 161 connected to the first light emitting diode array 143, and a third light emitting diode connection resistor, that is, the resistor 163 connected to the third light emitting diode array, such that the amount of output light from the third light emitting diode becomes relatively greatest.

Alternatively, the second light emitting diode connection resistor 162 may also be set to have a resistance value lower than a resistance value of a different light emitting diode connection resistor, that is, may appropriately be set in consideration of a flicker phenomenon improvement effect.

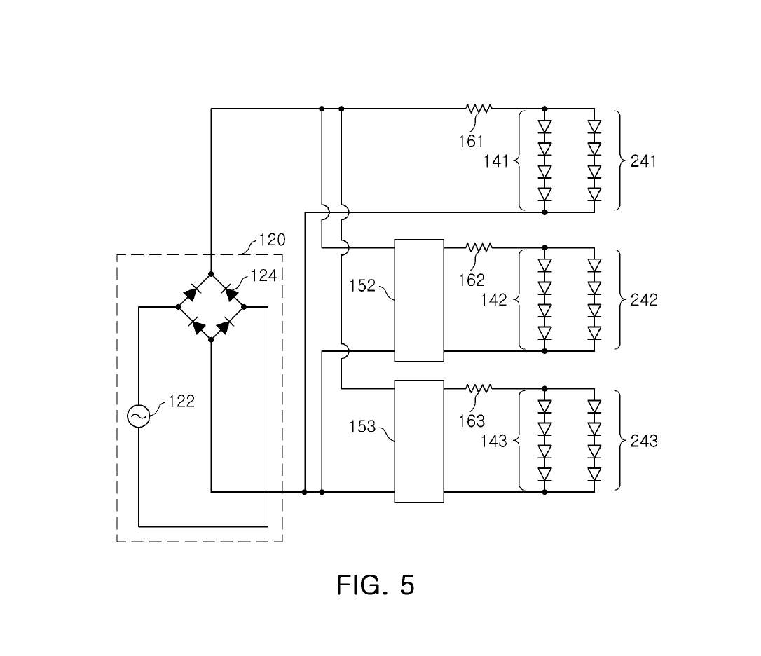

FIG. 5 is a schematic equivalent circuit diagram of a light emitting apparatus according to another embodiment of the present inventive concept. With reference to FIG. 5, at least one of the plurality of light emitting diode arrays 141, 142 and 143 may include subarrays 241, 242 and 243 connected thereto in parallel.

The subarrays may have an array structure in which at least one or more light emitting diodes are connected in series, and the number of light emitting diodes included therein may be one or more, that is, may be appropriately selected as one or more.

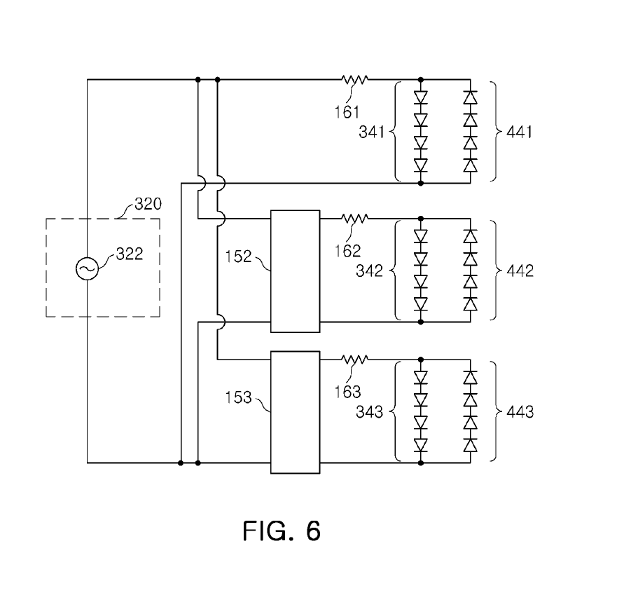

On the other hand, the light emitting apparatus according to an embodiment of the present inventive concept may also be driven by a power supply that does not include a rectifier. FIG. 6 is a schematic equivalent circuit diagram of a light emitting apparatus according to another embodiment of the present inventive concept.

With reference to FIG. 6, a power supply 320 according to an embodiment of the present inventive concept may include an alternating current power source 322 which provides an alternating current power having a predetermined frequency to respective light emitting diode arrays 341, 342 and 343.

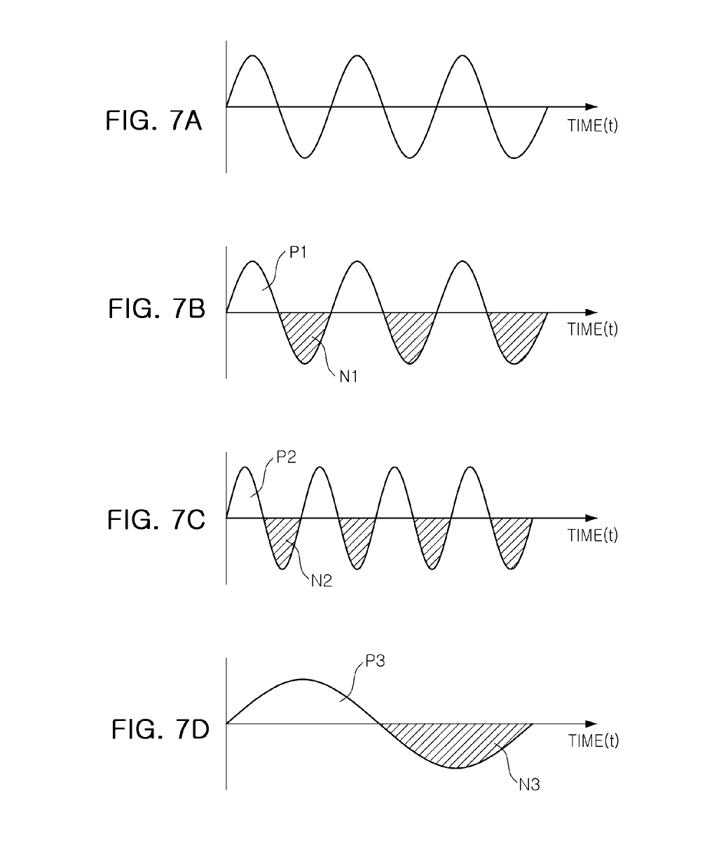

FIG. 7A schematically illustrates a voltage waveform of power having a predetermined frequency, provided from the power supply 320. FIG. 7B to FIG. 7D illustrate waveforms of power having a frequency modulated by the frequency converter 152 or 153 and then applied to the first to third light emitting diode arrays 341, 342 and 343.

In this case, the light emitting apparatus may include subarrays 441, 442 and 443 connected to at least one of the plurality of light emitting diode arrays 341, 342 and 343 in parallel, in a reverse direction to have a reverse polarity, such that the light emitting apparatus may also be driven by a negative direction voltage provided from the power supply 320. That is, the first to third light emitting diode arrays 341, 342 and 343 may be respectively driven in positive voltage portions P1 to P3 illustrated in FIGS. 7B to 7D, and the subarrays 441, 442 and 443 of the first to third light emitting diode arrays may be respectively driven in negative voltage portions N1 to N3.

In the light emitting apparatus according to an embodiment of the present inventive concept, the light emitting diode arrays and the subarrays alternately emit light, whereby the light emitting apparatus may be driven with regard to alternating current power without a rectifier, and a flicker phenomenon may be improved.

As set forth above, according to an embodiment of the present inventive concept, a light emitting apparatus may be provided to be driven with respect to alternating current power such that a flicker phenomenon is improved.

While the present inventive concept has been shown and described in connection with the embodiments thereof, it will be apparent to those skilled in the art that modifications and variations can be made without departing from the spirit and scope of the inventive concept as defined by the appended claims.

What is claimed is:

1. A light emitting apparatus, comprising:
a power supply providing power having a predetermined frequency;
a plurality of light emitting diode arrays electrically connected to the power supply and respectively having an array structure in which at least one or more light emitting diodes are connected to one another in series; and
at least one frequency converter connected to both ends of the power supply, and configured to modulate a frequency of the power provided from the power supply and provide a modulated electrical signal to at least one of the plurality of light emitting diode arrays.

2. The light emitting apparatus of claim 1, wherein:
the at least one frequency converter are a plurality of frequency converters, and
at least two of the plurality of light emitting diode arrays respectively receive the modulated electrical signal from at least two of the plurality of frequency converters, such that amounts of frequency modulation of the at least two frequency converters are different from each other.

3. The light emitting apparatus of claim 2, wherein the amounts of frequency modulation of the at least two frequency converters are set to increase the frequency of power provided from the power supply.

4. The light emitting apparatus of claim 2, wherein the amounts of frequency modulation of the at least two frequency converters are set to decrease the frequency of power provided from the power supply.

5. The light emitting apparatus of claim 2, wherein:
at least one of the at least two frequency converters is set to increase the frequency of power provided from the power supply, and
the remaining one of the at least two frequency converters is set to decrease the frequency of power provided from the power supply.

6. The light emitting apparatus of claim 1, wherein at least one of the plurality of light emitting diode arrays further includes a resistor connected to the at least one light emitting diode array in series, such that the resistor controls an amount of current conducting the at least one light emitting diode array.

7. The light emitting apparatus of claim 6, wherein a resistance value of the resistor is set such that a frequency of power conducting the light emitting diode array including the resistor is not higher than a frequency of power conducting a different light emitting diode array.

8. The light emitting apparatus of claim 6, wherein a resistance value of the resistor is set such that a frequency of power conducting the light emitting diode array including the resistor is not lower than a frequency of power conducting a different light emitting diode array.

9. The light emitting apparatus of claim 1, wherein the power supply includes an alternating current power source having a predetermined frequency and a rectifier connected to both ends of the alternating current power source to rectify alternating current power to provide the rectified alternating current power.

10. The light emitting apparatus of claim 9, wherein:
at least one of the plurality of light emitting diode arrays further includes a subarray connected to the at least one light emitting diode array in parallel, and
the subarray has an array structure in which at least one or more light emitting diodes are connected in series.

11. The light emitting apparatus of claim 1, wherein:
at least one of the plurality of light emitting diode arrays further includes a subarray connected to the at least one light emitting diode array in parallel, and
the subarray has an array structure in which at least one or more light emitting diodes are connected in series, and has a reverse polarity with respect to a polarity of the at least one light emitting diode array.

12. A light emitting apparatus, comprising:
a power supply providing power having a predetermined frequency;
a plurality of light emitting diode arrays respectively having an array structure in which at least one or more light emitting diodes are connected to one another in series; and
a plurality of frequency converters connected to both ends of the power supply and configured to modulate a frequency of the power provided from the power supply and provide modulated electrical signals to respective ones of the plurality of light emitting diode arrays such that frequencies of the modulated electrical signals are different from one another.

13. The light emitting apparatus of claim 12, wherein amounts of frequency modulation of the plurality of frequency converters are set to increase the frequency of power provided from the power supply.

14. The light emitting apparatus of claim 12, wherein amounts of frequency modulation of the plurality of frequency converters are set to decrease the frequency of power provided from the power supply.

15. The light emitting apparatus of claim 12, wherein:
at least one of the plurality of frequency converters is set to increase the frequency of power provided from the power supply, and
the remaining ones of the plurality of frequency converters are set to decrease the frequency of power provided from the power supply.

16. The light emitting apparatus of claim 12, wherein at least one of the plurality of light emitting diode arrays further includes a resistor connected to the at least one light emitting diode array in series, such that the resistor controls an amount of current conducting the at least one light emitting diode array.

17. The light emitting apparatus of claim 16, wherein a resistance value of the resistor is set such that a frequency of power conducting the light emitting diode array including the resistor is not higher than a frequency of power conducting a different light emitting diode array.

18. The light emitting apparatus of claim 16, wherein a resistance value of the resistor is set such that a frequency of power conducting the light emitting diode array including the resistor is not lower than a frequency of power conducting a different light emitting diode array.

19. The light emitting apparatus of claim 12, wherein the power supply includes an alternating current power source having a predetermined frequency and a rectifier connected to both ends of the alternating current power source to rectify alternating current power to provide the rectified alternating current power.

20. The light emitting apparatus of claim 12, wherein:
at least one of the plurality of light emitting diode arrays further includes a subarray connected to the at least one light emitting diode array in parallel, and
the subarray has an array structure in which at least one or more light emitting diodes are connected in series, and has a reverse polarity with respect to a polarity of the at least one light emitting diode array.
